(19) United States
(12) Patent Application Publication
(10) Pub. No.: US 2026/0011960 A1
(43) Pub. Date: Jan. 8, 2026

(54) COMPONENT-ATTACHED CONNECTOR

(71) Applicant: Yazaki Corporation, Tokyo (JP)

(72) Inventors: Hiraku TANAKA, Makinohara-shi (JP); Yusuke YAMADA, Makinohara-shi (JP); Akinori SAKAMOTO, Makinohara-shi (JP)

(73) Assignee: Yazaki Corporation, Tokyo (JP)

(21) Appl. No.: 19/226,316

(22) Filed: Jun. 3, 2025

(30) Foreign Application Priority Data
Jul. 8, 2024 (JP) 2024-109507

(51) Int. Cl. H01R 13/66

(52) U.S. Cl. CPC H01R 13/6683

(57) ABSTRACT

A component-attached connector configured to be connected to a detection target to detect a physical quantity of the detection target, includes: a connection component configured to be connected to the detection target; an electrical component including an electrical component main body connected to the connection component to detect the physical quantity, and a pair of terminal portions connected to the electrical component main body and formed to extend in a direction away from the connection component; and a housing that holds the connection component and the electrical component, wherein the pair of terminal portions are configured to be connected to counterpart terminals of a counterpart connector.

### TECHNICAL FIELD

The present invention relates to a component-attached connector.

### BACKGROUND

A conventional example of a wire harness routed in a vehicle includes a bus bar for detecting the temperature of an electronic component, the bus bar being bolted to the electronic component, a temperature sensor for detecting the temperature of the electronic component via the bus bar, a housing for holding the bus bar and the temperature sensor, electric wires connected to the temperature sensor and extending from the housing, and a connector portion provided at ends of the electric wires to be engaged with another connector (see, for example, Patent Document 1).

When such a conventional wire harness is routed in a vehicle, the bus bar is bolted to the electronic component while the temperature sensor is connected to the electric wires at one end, and then the connector portion is engaged with another connector while the electric wires are routed at the other end, and the another connector is fixed to the vehicle body. In this manner, the conventional wire harness is routed in the vehicle.

### RELATED ART

### Patent Document

Patent Document 1: JP2021158859 A

### SUMMARY OF THE INVENTION

### Problem to Be Solved by the Invention

However, conventional wire harnesses require many assembly steps, such as connecting one end of each electric wire to a temperature sensor and providing a connector portion to the electric wires at the other end.

It is an object of the present invention to provide a component-attached connector that improves the efficiency of assembly tasks.

### Solution to Problem

In order to solve the above problems and achieve the above objects, the invention set forth in claim 1 is a component-attached connector configured to be connected to a detection target to detect a physical quantity of the detection target, including a connection component configured to be connected to the detection target, an electrical component including an electrical component main body connected to the connection component to detect the physical quantity, and a pair of terminal portions connected to the electrical component main body and formed to extend in a direction away from the connection component, and a housing that holds the connection component and the electrical component, wherein the pair of terminal portions are configured to be connected to counterpart terminals of a counterpart connector.

### Advantageous Effects of the Invention

According to the invention set forth in claim 1, the efficiency of assembly tasks can be improved.

### BRIEF DESCRIPTION OF THE DRAWINGS

FIG. 1 is a perspective view illustrating a state in which a component-attached connector according to one embodiment of the present invention is bolted to a detection target.

FIG. 2 is a perspective view illustrating the component-attached connector.

FIG. 3 is a longitudinal sectional view of the component-attached connector.

FIG. 4 is a transparent view illustrating the inside of a housing that constitutes the component-attached connector.

FIG. 5 is a perspective view for explaining a process for manufacturing the component-attached connector.

FIG. 6 is a diagram illustrating a step subsequent to the step illustrated in FIG. 5.

FIG. 7 is a perspective view illustrating a modified example of the component-attached connector.

FIG. 8 is a longitudinal sectional view illustrating a process for manufacturing the component-attached connector.

### DETAILED DESCRIPTION OF THE EXEMPLARY EMBODIMENT

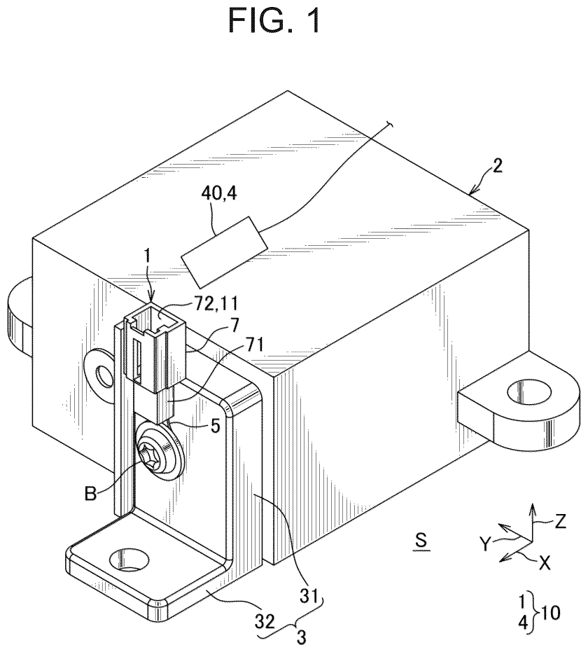

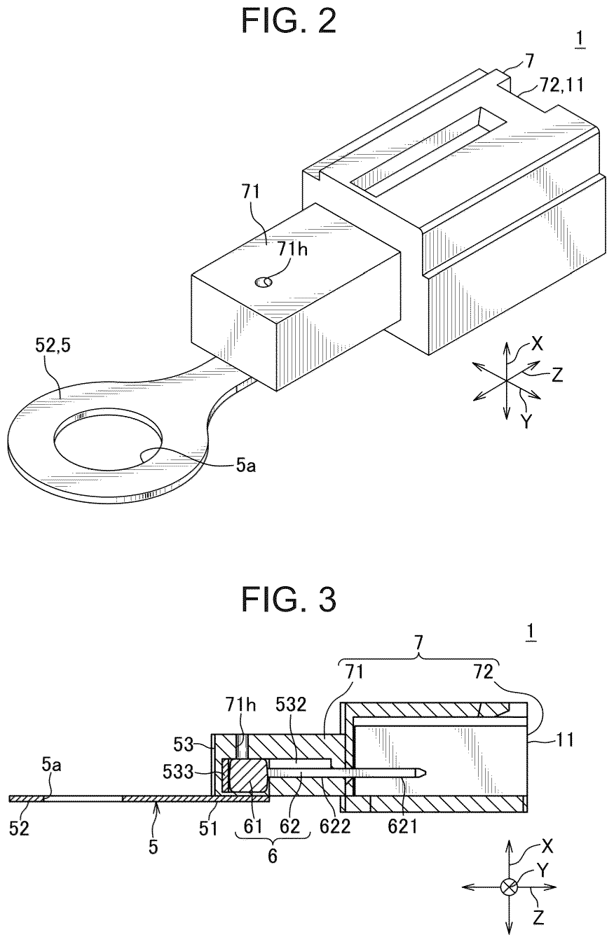

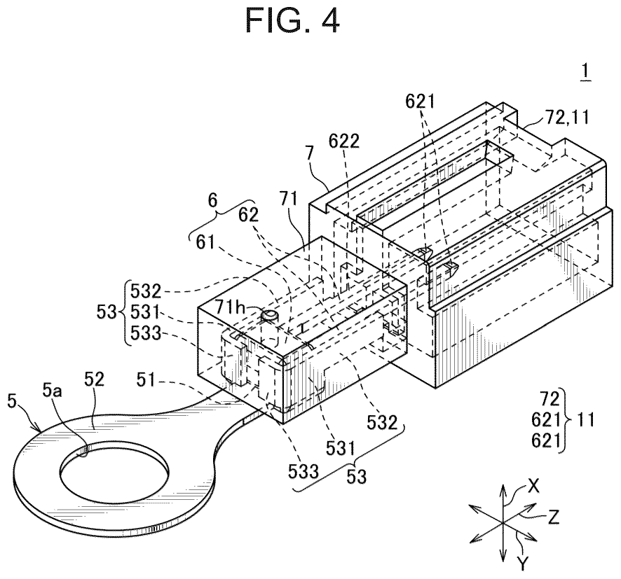

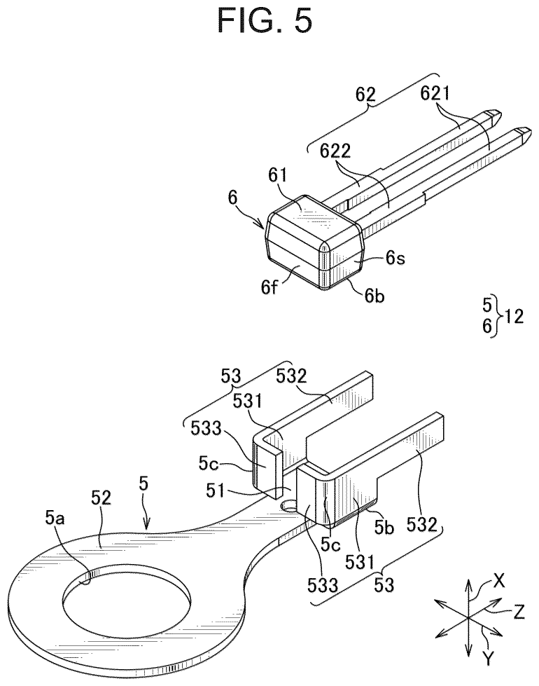

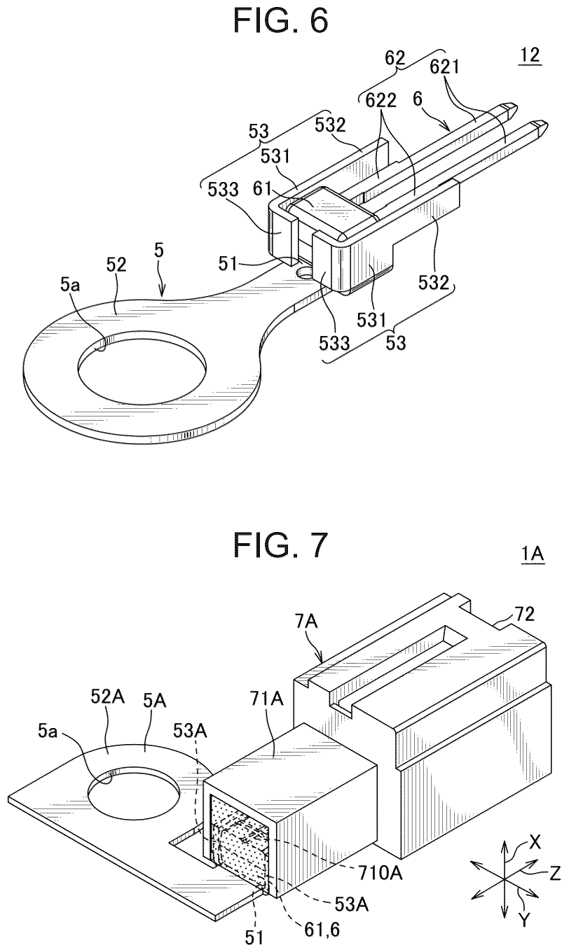

Hereinafter, one embodiment of the present invention is described with reference to FIGS. 1 to 6. FIG. 1 is a perspective view illustrating a state in which a component-attached connector 1 according to one embodiment of the present invention is bolted to a detection target. FIG. 2 is a perspective view illustrating the component-attached connector 1. FIG. 3 is a longitudinal sectional view of the component-attached connector 1. FIG. 4 is a transparent view illustrating the inside of a housing 7 that constitutes the component-attached connector 1. FIG. 5 is a perspective view for explaining a process for manufacturing the component-attached connector 1. FIG. 6 is a diagram illustrating a step subsequent to the step illustrated in FIG. 5.

As illustrated in FIG. 1, the component-attached connector 1 is connected via a copper L-shaped bracket 3 to an electrical junction box 2 (detection target) mounted on a vehicle, and is for detecting the temperature (physical quantity) of the electrical junction box 2. The component-attached connector 1 is connected to a counterpart connector 4 to form a wire harness 10 that is routed in the vehicle.

As illustrated in FIG. 1, the electrical junction box 2 is mounted on a vehicle installation surface S of the vehicle and distributes power from the power source side to the load side, and the electrical junction box 2 according to the present embodiment is provided in a substantially rectangular parallelepiped shape. This electrical junction box 2 is fixed to the vehicle installation surface S by the L-shaped bracket 3, explained later.

In the following, arrows X, Y, and Z are perpendicular to each other. The arrows X and Y are directions in which the vehicle installation surface S extends, the arrow Z is a direction in which the electrical junction box 2 is located relative to the vehicle installation surface S, and the arrow X is a direction in which the electrical junction box 2, the component-attached connector 1, and the L-shaped bracket 3 overlap.

As illustrated in FIG. 1, the L-shaped bracket 3 is formed in an L-shape which includes a first plate portion 31 in a rectangular shape and a second plate portion 32 in a rectangular shape, and the second plate portion 32 is bent at a boundary position between the first plate portion 31 and the second plate portion 32 and extends. The first plate portion 31 is configured to overlap a side surface of the electrical junction box 2 and bolted thereto together with a lug terminal 5 of the component-attached connector 1 by using a bolt B, and the second plate portion 32 is configured to be bolted to the vehicle installation surface S.

As illustrated in FIGS. 2 to 4, the component-attached connector 1 includes the lug terminal 5 (connection component) that is bolted to the electrical junction box 2 via the L-shaped bracket 3, a sensor component 6 (electrical component, illustrated in FIGS. 3 and 4) for detecting the temperature of the electrical junction box 2, and a housing 7 that holds the lug terminal 5 and the sensor component 6 and is connected to the counterpart connector 4.

As illustrated in FIGS. 4 and 5, the lug terminal 5 is formed by punching and bending a metal plate, and includes a placement portion 51 on which the sensor component 6 described later is placed, a fastening portion 52 which is bolted to the electrical junction box 2, and a heat sink portion 53 which dissipates heat from the sensor component 6.

As illustrated in FIG. 5, the placement portion 51 is formed in the same rectangular shape as a lower surface 6b of the sensor component 6 described later, and is provided in contact with (connected to) a lower surface 6b of the sensor component 6 described later. This placement portion 51 is provided to extend in a plane including the arrows YZ.

As illustrated in FIG. 5, the fastening portion 52 is continuous with one side of the placement portion 51 in the direction of the arrow Z, and is configured to have a hole portion 5a through which the bolt B is inserted.

As illustrated in FIG. 5, the heat sink portion 53 is integrally provided with a pair of heat sink portion main bodies 531, 531 (bent pieces) continuing on both sides of the placement portion 51 in the direction of the arrow Y, a pair of extension pieces 532, 532 continuing on one side of the respective heat sink portion main bodies 531 in the direction of the arrow Z, and a pair of continuous pieces 533, 533 continuing on the other side of the respective heat sink portion main bodies 531 in the direction of the arrow Z. Since the heat sink portion 53 is thus provided, the heat sink portion 53 absorbs heat from a thermistor device 61, alleviating a temperature rise of the thermistor device 61.

As illustrated in FIG. 5, the pair of heat sink portion main bodies 531, 531 are bent relative to the placement portion 51 and extend in a direction away from the placement portion 51, and are provided in contact with a side surface 6s of the sensor component 6 described later.

As illustrated in FIG. 5, the pair of extension pieces 532, 532 are provided facing each other in the direction of the arrow Y, and are provided extending in the direction of the arrow Z on the opposite side of the respective heat sink portion main bodies 531 from the fastening portion 52. The pair of extension pieces 532, 532 are provided on both sides, in the direction of the arrow Y, of a pair of terminal portions 62, 62 extending from the sensor component 6 described later.

As illustrated in FIG. 5, the pair of continuous pieces 533, 533 are arranged side by side in the direction of the arrow Y, and are bent relative to the respective heat sink portion main bodies 531 and overlap a front surface 6f of the sensor component 6 described later.

In order to manufacture the lug terminal 5, as illustrated in FIG. 5, a punching process is performed on a conductive metal plate to produce a punched portion, not illustrated, having the hole portion 5a, and then each heat sink portion main body 531 is folded against the placement portion 51 at boundary portions 5b between the placement portion 51 and each heat sink portion main body 531, and each continuous piece 533 is folded relative to the heat sink portion main body 531 at a boundary portion 5c between the heat sink portion main body 531 and the continuous piece 533, and thus the lug terminal 5 is manufactured.

As illustrated in FIG. 5, the sensor component 6 includes a thermistor device 61 (electrical component main body) placed on the placement portion 51 of the lug terminal 5, and a pair of terminal portions 62, 62 extended from the thermistor device 61.

The pair of terminal portions 62, 62 are arranged in parallel to each other in the direction of the arrow Y. One end side (proximal end side) of each terminal portion 62 is electrically connected to the thermistor device 61, and the other end side (distal end side) is formed to extend in the opposite direction to the fastening portion 52 of the lug terminal 5 in the direction of the arrow Z.

Each terminal portion 62 includes a terminal main body 621 that can be engaged with (connected to) a counterpart terminal, not illustrated, of the counterpart connector 4 and a device connection portion 622 that is continuous with the terminal main body 621 and is electrically connected to the thermistor device 61. The terminal main body 621 and the device connection portion 622 are formed in a rod shape extending in the direction of the arrow Z.

As illustrated in FIGS. 2 to 4, the housing 7 is integrally provided with a holding portion 71 that embeds and holds the placement portion 51 of the lug terminal 5 and the sensor component 6, and a connector housing 72 that can be engaged with (connected to) the counterpart connector housing 40 of the counterpart connector 4.

As illustrated in FIGS. 2 to 4, the holding portion 71 has a rectangular parallelepiped outer shape. The holding portion 71 is formed by embedding the placement portion 51 of the lug terminal 5, the heat sink portion main bodies 531, the extension pieces 532, and the continuous pieces 533, the thermistor device 61 in the sensor component 6, and the device connection portions 622 of the pair of terminal portions 62, 62. This holding portion 71 has a hole portion 71h that is created when the component-attached connector 1 is manufactured. This hole portion 71h is a result of a rod member, not illustrated, being inserted to press the thermistor device 61 against the placement portion 51 so that a contact state between the placement portion 51 of the lug terminal 5 and the thermistor device 61 is maintained during the process of manufacturing the component-attached connector 1.

As illustrated in FIGS. 2 to 4, the connector housing 72 is continuous with the holding portion 71 and is configured in a tubular shape that opens on the opposite side from the fastening portion 52 of the lug terminal 5. The connector housing 72 surrounds the terminal main bodies 621 of the pair of terminal portions 62, 62 and is configured to be able to engage with the counterpart connector housing 40. Additionally, inside the connector housing 72, the pair of terminal portions 62, 62 are provided extending in the same direction (arrow Z) as the axial direction of the connector housing 72. Hereinafter, a portion that includes the connector housing 72 and the terminal main bodies 621 of the pair of terminal portions 62, 62 configured to be connected to the counterpart connector 4 may be referred to as a “connector portion 11”.

When the component-attached connector 1 is manufactured, as illustrated in FIGS. 5 and 6, the sensor component 6 is placed with the lower surface 6b of the thermistor device 61 close to the placement portion 51 of the lug terminal 5, with the pair of terminal portions 62, 62 extending away from the fastening portion 52 of the lug terminal 5. The lower surface 6b of the thermistor device 61 is provided to be in contact with the placement portion 51 of the lug terminal 5, the side surfaces 6s of the thermistor device 61 are provided to be in contact with the respective heat sink portion main bodies 531, and the front surface 6f of the thermistor device 61 is provided to be in contact with the continuous pieces 533. The lug terminal 5 and the sensor component 6 in this state may be referred to as a “metal component 12 (illustrated in FIG. 6)”.

Next, the metal component 12 is inserted into a mold, not illustrated, and the thermistor device 61 is pressed against the placement portion 51 using the rod member (not illustrated), while molten resin is injected into the mold. The molten resin is then hardened, and the rod member, not illustrated, is pulled out. In this manner, the manufacture of the component-attached connector 1, in which the metal component 12 and the housing 7 are integrated, is completed by insert molding.

When the component-attached connector 1, manufactured in this manner, is assembled to the electrical junction box 2, the shank of the bolt B is inserted into the hole portion 5a of the fastening portion 52, with the first plate portion 31 of the L-shaped bracket 3 overlapping the electrical junction box 2, and the component-attached connector 1 as well as the first plate portion 31 are bolted together to the electrical junction box 2, thereby connecting the lug terminal 5 to the electrical junction box 2 and completing the assembly of the component-attached connector 1 to the electrical junction box 2.

Thereafter, the connector housing 72 constituting the connector portion 11 of the component-attached connector 1 is engaged with the counterpart connector housing 40, and the terminal main bodies 621 of the pair of terminal portions 62, 62 are engaged with the counterpart terminals, and the connector portion 11 is connected to the counterpart connector 4. In other words, the pair of terminal portions 62, 62 are connected to the counterpart terminals of the counterpart connector 4.

Thus, the wire harness 10 to be routed in the vehicle is completed. At this point, the sensor component 6 can detect the heat of the electrical junction box 2 through the L-shaped bracket 3 and the lug terminal 5.

According to the above-described embodiment, the pair of terminal portions 62, 62 and the counterpart terminals of the counterpart connector 4 are directly connected to form the wire harness 10. This makes it possible to omit steps of tasks required in assembling a wire harness, such as a step of connecting one end of each electric wire to the sensor component and the step of providing a connector portion to the electric wires at the other end, as in the conventional technology, thereby making it possible to improve the efficiency of the assembly tasks.

The thermistor device 61 (electrical component main body) is composed of the thermistor device 61 capable of detecting the temperature (physical quantity) of the electrical junction box 2 (detection target), and the lug terminal 5 (connection component) includes the placement portion 51 in a plate shape on which the thermistor device 61 is placed, and the heat sink portion main bodies 531 (bent pieces) that are continuous with the placement portion 51 and are bent to come into contact with the side surfaces 6s of the thermistor device 61. As a result, the heat sink portion main bodies 531 absorb the heat from the thermistor device 61, making it possible to alleviate a temperature rise of the thermistor device 61.

Furthermore, the lug terminal 5 (connection component) includes extension pieces 532 that are continuous with the heat sink portion main bodies 531 (bent pieces) and extend in a direction away from the placement portion 51. Accordingly, the heat sink portion main bodies 531 and the extension pieces 532 absorb the heat from the thermistor device 61, thereby further alleviating a temperature rise of the thermistor device 61.

The present invention is not limited to the above-described embodiment, and includes other configurations that can achieve the object of the present invention, and the following modifications are also included in the present invention.

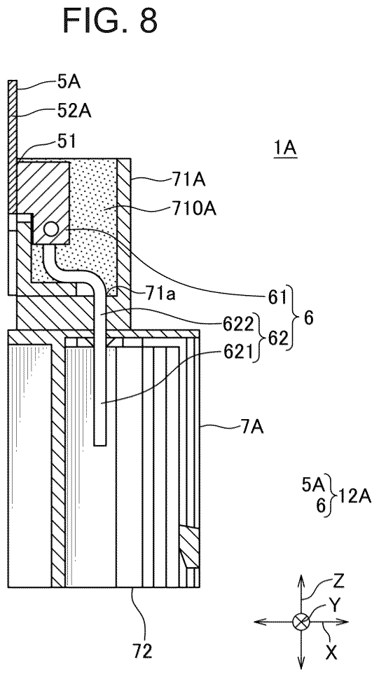

In the above embodiment, the component-attached connector 1 in which the metal component 12 and the housing 7 are integrated is manufactured by insert molding, but the present invention is not limited thereto. A component-attached connector 1A, which is a modified example of the component-attached connector 1, may be configured by applying a potting material 710A to the inside of a holding portion 71A, as illustrated in FIGS. 7 and 8. Furthermore, the lug terminal 5A of the component-attached connector 1A and the lug terminal 5 of the component-attached connector 1 may have different shapes. FIG. 7 is a perspective view illustrating a modified example of the component-attached connector 1A. FIG. 8 is a longitudinal sectional view illustrating a process for manufacturing the component-attached connector 1A. In FIGS. 7 and 8, portions having the same shape or configuration as those of the component-attached connector 1 according to the embodiment are labeled with the same reference numerals as those of the component-attached connector 1, and the descriptions of those portions are omitted.

As illustrated in FIGS. 7 and 8, the component-attached connector 1A includes a lug terminal 5A (connection component) that is bolted to an electrical junction box 2 (illustrated in FIG. 1) via an L-shaped bracket 3 (illustrated in FIG. 1), a sensor component 6 for detecting the temperature of the electrical junction box 2, and a housing 7A that holds the lug terminal 5A and the sensor component 6 and is connected to a counterpart connector 4 (illustrated in FIG. 1).

As illustrated in FIG. 7, the lug terminal 5A is formed by punching and bending a metal plate, and includes a placement portion 51 on which the sensor component 6 is placed, a fastening portion 52A that is bolted to the electrical junction box 2, and a heat sink portion 53A that is bent from the fastening portion 52A and is in contact with the sensor component 6 to dissipate heat from the sensor component 6.

The fastening portion 52A is continuous with the placement portion 51, extends to one side of the arrow Y, and is arranged side by side with the placement portion 51 on the one side of the arrow Y. This fastening portion 52A is configured to have a hole portion 5a through which a bolt B is inserted. In this way, the shape of the fastening portion 52A only needs to be configured to match the shape of the object to be fastened, and the fastening portion 52A can be adapted to various objects to be fastened simply by changing the shape of the fastening portion 52A.

As illustrated in FIG. 8, the housing 7A is integrally provided with a holding portion 71A that holds the placement portion 51 of the lug terminal 5 and the sensor component 6 and is coated with the potting material 710A, and a connector housing 72 that can be engaged with (connected to) the counterpart connector housing 40 of the counterpart connector 4. The holding portion 71A is configured to have a pair of insertion holes 71a, 71a (only one is illustrated in FIG. 8), into which the pair of terminal portions 62, 62 can be inserted, at a boundary portion between the connector housing 72 and the holding portion 71A.

As illustrated in FIG. 8, the component-attached connector 1A is manufactured by placing the thermistor device 61 of the sensor component 6 on the placement portion 51 of the lug terminal 5A to make a metal component 12A, and then, with the pair of terminal portions 62, 62 of the metal component 12A being inserted into the respective insertion holes 71a of the housing 7A, the potting material 710A is applied to the inside of the holding portion 71A to produce the component-attached connector 1A in which the metal component 12A and the housing 7A are integrated. In this manner, the component-attached connector 1A may be constructed by applying the potting material 710A to the inside of the holding portion 71A. After this, the component-attached connector 1A is connected to the counterpart connector 4. That is, the pair of terminal portions 62, 62 are connected to the counterpart terminals of the counterpart connector 4. According to this configuration, the same effects as the above embodiment are achieved.

In the above embodiment, the sensor component 6 that detects the temperature of the electrical junction box 2 is used as an example of the electrical component, but the present invention is not limited thereto. The electrical component may be a component that detects the voltage or the current of the detection target, or a component that detects other physical quantities.

In addition, the best configurations and methods for implementing the present invention are disclosed in the above description, but the present invention is not limited thereto. That is, although the present invention has been mainly illustrated and described with reference to specific embodiments, those skilled in the art can make various modifications to the above-described embodiments in terms of shape, material, quantity, and other detailed configurations without departing from the scope of the technical idea and purpose of the present invention. Therefore, it should be understood that the descriptions limiting the shapes, materials, and the like disclosed above are illustrative descriptions for the purpose of facilitating understanding of the present invention, and do not limit the present invention, and therefore descriptions of the names of components that do not include some or all of the limitations on the shapes, materials, and the like are included in the present invention.

### LIST OF REFERENCE SIGNS

1, 1A component-attached connector
2 electrical junction box (detection target)
5, 5A lug terminal (connection component)
6 sensor component (electrical component)
7, 7A housing
51 placement portion
531 heat sink portion main body (bent piece)
532 extension piece
61 thermistor device (electrical component main body)
62, 62 a pair of terminal portions

1. A component-attached connector configured to be connected to a detection target to detect a physical quantity of the detection target, comprising:
a connection component configured to be connected to the detection target;
an electrical component including an electrical component main body connected to the connection component to detect the physical quantity, and a pair of terminal portions connected to the electrical component main body and formed to extend in a direction away from the connection component; and
a housing that holds the connection component and the electrical component,
wherein the pair of terminal portions are configured to be connected to counterpart terminals of a counterpart connector.

2. The component-attached connector according to claim 1, wherein the electrical component main body is composed of a thermistor device capable of detecting temperature as the physical quantity, and
the connection component includes:
a placement portion in a plate shape on which the electrical component main body is placed; and
a bent piece that is continuous with the placement portion and is bent to come into contact with a side surface of the electrical component main body.

3. The component-attached connector according to claim 2, wherein the connection component includes an extension piece that is formed to be continuous with the bent piece and extends in a direction away from the placement portion.
